(19) United States
(12) Patent Application Publication
(10) Pub. No.: US 2015/0341208 A1
(43) Pub. Date: Nov. 26, 2015

(54) DEVICE FOR MANAGING AND CONFIGURING FIELD DEVICES IN AN AUTOMATION INSTALLATION

(71) Applicant: ABB Technology AG, Zurich (CH)

(72) Inventors: Dirk WAGENER, Stadthagen (DE); Christoph WELTE, Neu-Ulm (DE); Marcus HEEGE, Kaisersesch (DE); Wolfgang MAHNKE, Hettenleidelheim (DE); Marko SCHLUTER, Espelkamp (DE)

(73) Assignee: ABB TECHNOLOGY AG, Zurich (CH)

(21) Appl. No.: 14/717,321

(22) Filed: May 20, 2015

(30) Foreign Application Priority Data
May 20, 2014 (DE) 102014007383.1

(51) Int. Cl. H04L 12/24; G06F 3/0484; G06F 3/0482

(52) U.S. Cl. CPC H04L 41/0806; H04L 41/22; H04L 41/12; G06F 3/0482; G06F 3/04842

(57) ABSTRACT

A method and a device are disclosed for managing and configuring field devices in an automation installation with a configuration tool which is designed to physically detect a field device in the automation installation, to logically incorporate the field device into the automation installation, and to configure the field in the automation installation, the configuration tool including a predefined first field-device-specific information packet which at least partially describes the functions and data of the field device. The field devices can be represented in each case by identical screen elements in the configuration tool, which screen elements have a same construction and same functions independently of a location of a device selection.

### RELATED APPLICATION(S)

This application claims priority under 35 U.S.C. §119 to German Patent Application No. 102014007383.1, filed on May 20, 2014, the entire content of which is hereby incorporated by reference in its entirety.

### FIELD

The disclosure relates to a method and a device for managing and configuring field devices in an automation installation. The disclosure can be used, for example, in process automation or machine control for controlling processes and/or installation components.

### BACKGROUND INFORMATION

Automation systems for controlling a technical process or a technical installation can include a control device (PLC) which can be integrated in a group of a multiplicity of intelligent electrical devices. Intelligent electronic devices can include microprocessor-based devices, for example, protective and control devices, motor protective devices, intelligent switches and voltage regulators, frequency converters, pressure and temperature measuring transducers, flowmeters and actuators.

The article “FDI Device Integration—Best of Both Worlds”, atp edition June 2010, pages 16 to 19, discloses the practice of integrating field devices into an automation installation using the FDI concept (Field Device Integration IEC-62769). The basis of this concept can be the provision of information for configuring field devices in a device-specific FDI packet. This FDI packet can include a firmly predefined amount of information, which can include a device definition, business logic, a user interface description and user interface plug-ins. For example, the device definition can include management information and the device model. The business logic can describe the communication logic for the device and can be used to help ensure consistency of the device model. The user interface description describes the presentation of the device parameters and device functions. The user interface plug-ins can be programmed components of interface portions for displaying the device parameters and functions.

When configuring field devices by EDD (electronic device description) technology IEC 61804, a device manufacturer provides an EDD which can include information relating to the communication with the device, the business logic and the user interfaces, for example, which input masks should be displayed for a user. The business logic can include, for example, when which parameters can be written.

FDI technology uses these EDD mechanisms and provides the concept of the FDI package which, in addition to an EDD, may also include other information such as a user handbook or else so-called UIPs (user interface plug-in) which provide further user interfaces in other technologies, for example .NET assemblies, which, in contrast to EDD-based user interfaces, consist of programmed code compiled for a component.

FDI packets can be created by device manufacturers and can be used by system manufacturers to integrate and configure the devices from the device manufacturers in their system.

In addition to an individual user element having different parameters, graphs and other elements, new windows and dialogs may also be defined in the EDD. In this case, a host has certain freedoms and can display a plurality of menus defined in the EDD in different windows at the same time, for example, or else user interfaces of different device entities.

Known EDD host systems either restrict the number of windows or open an arbitrary number of windows for the different devices. In this case, the overview of the assignment of the windows to the devices can be lost.

In addition, the EDD specification can allow an input context to be defined, which input context can include changes to a device configuration, which have already been made by the user at the interface but have not yet been written to the device or the offline configuration. According to the specification, in this case, different windows and dialogs, for example, can work on different input contexts of the same device, which can make it even more difficult for a user to assign the windows not only to the device but also to a particular input context.

According to known art, EDD host systems display the windows described in the EDD as windows of the application, with the result that the user can compare a plurality of window contents with one another. However, the windows can be assigned to a particular device entity only with difficulty and can be assigned to a particular input context of this device entity with even more difficulty. If a user wishes to use or reject an input context, it can be therefore difficult to discern which windows are affected thereby.

In such a programming tool, information relating to the devices can be visualized and functions, such as parameter setting, are executed. For this purpose, a device is first to be selected by the user from a multiplicity of devices.

Furthermore, in known programming tools, the same device can be represented in various ways. Thus, a different device object and symbol can be displayed in the hierarchic structure than in the list representation of the devices. The device functionality also differs based on the display format. The display is not consistent and can be therefore difficult for a user to learn. The different displays also differ with respect to device functionalities, which the user can execute. Thus, the user cannot execute the same device functionalities in the list representation as if he chose the device object in the tree. The user should therefore know which device functions the user can find and execute in which display.

A screen element, HMI device, automation system and computer program product for visualizing and projecting user texts which are used once and more than once and the associated points of use in a data processing system are known from DE 102 45 890 B4. What can be gathered from the disclosure can be that devices are provided for selection in a hierarchical tree structure, wherein a user text can be associated with each branch which branches further and a combination of a user text and a point of use can be associated with each branch which does not branch further. Details relating to a device are stored in nested menu levels. Hence, the operation and, for example, the search for details relating to a device becomes a time-consuming process.

Exemplary embodiments of the present disclosure can be therefore specify a device for managing and configuring field devices in an automation installation, the clarity of which can be maintained, even in the case of a multiplicity of devices and functions being handled simultaneously.

### SUMMARY

A device is disclosed for managing and configuring field devices in an automation installation, the device comprising: a configuration tool which is configured to physically detect a field device in the automation installation, to logically incorporate the field device into the automation installation, and to configure the field device in the automation installation, the configuration tool including a predefined first field-device-specific information packet which at least partially describes functions and data of the field device; and wherein the configuration tool is configured to represent all field devices in each case by identical screen elements, and wherein each of the identical screen elements has a same construction and a same function independently of a location of a device selection.

A method is disclosed for managing and configuring field devices in an automation installation, the method comprising: configuring a configuration tool to physically detect a field device in the automation installation, to logically incorporate the field device into the automation installation and to configure the field device in the automation installation, the configuration tool including a predefined first field-device-specific information packet which at least partially describes functions and data of the field device; and representing all field devices in each case by identical screen elements in the configuration tool, wherein each of the identical screen elements has a same construction and a same function independently of a location of a device selection.

### BRIEF DESCRIPTION OF THE DRAWINGS

The disclosure is explained below with reference to the exemplary embodiments shown in the drawings. In the drawings:

FIG. 1 shows an exemplary illustration of a screen element in the configuration tool according to an exemplary embodiment of the disclosure;

FIG. 2 shows an exemplary illustration of a device list in the configuration tool according to an exemplary embodiment of the disclosure; and

FIGS. 3a-3c show an exemplary illustration of the mode of operation of the expanded display of a screen element in the configuration tool according to an exemplary embodiment of the disclosure.

### DETAILED DESCRIPTION

In accordance with an exemplary embodiment, the disclosure is based on a device for managing and configuring field devices in an automation installation, with a configuration tool which can be designed to physically detect a field device in the automation installation, to logically incorporate it into the automation installation and to configure it in the automation installation, the configuration tool resorting for this purpose to a predefined first field-device-specific information packet which at least partially describes the functions and data of the field device.

According to the disclosure, provision can be made for all field devices to be represented in each case by identical screen elements in the configuration tool, which screen elements have the same construction and the same functions independently of the location of the device selection.

In accordance with an exemplary embodiment, the user can be therefore independent of the type of device selection and it can be irrelevant whether the device can be selected via a hierarchical tree structure or a device list because precisely the same device object with the same functionality can be found in both cases.

Each screen element can include at least, but not conclusively, an identifier and an operating element.

The identifier can be an unambiguous identification item of the field device within the automation installation. The identifier, a so-called “TAG name”, can be an alphanumeric description of a physical entity within an identification scheme of the respective automation installation.

The operating element can be a sensitive region of the screen element for calling expanded displays and/or functions of the field device. When the operating element can be actuated, the operating element can be expanded in terms of area. The additional display area can be suitable for displaying further device information.

According to another feature of the disclosure, the entire area of the screen element can be designed as a sensitive region.

According to another feature of the disclosure, the screen element has a topological indicator.

The topological indicator denotes the address of the field device in the automation installation, wherein the address can be understood as meaning any topological information by which the respective field device can be communicatively addressed.

According to another feature of the disclosure, the screen element has a status symbol. The status symbol can be an exchangeable graphical representation of the present availability state of the field device within the automation installation.

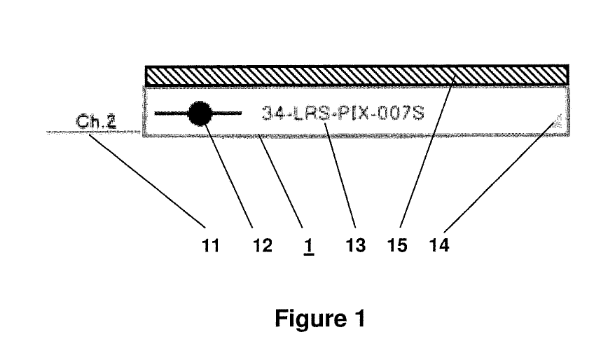

FIG. 1 is a basic illustration of an exemplary embodiment screen element 1 in the configuration tool. In an exemplary embodiment, each screen element 1 can include at least one topological indicator 11, a status symbol 12, an identifier 13 and an operating element 14.

All field devices are, for example, represented in each case by identical screen elements 1 in the configuration tool, which screen elements have the same construction and the same functions independently of the location of the device selection.

The topological indicator 11 denotes the address of the field device in the automation installation, wherein the address can be understood as meaning any topological information by which the respective field device can be communicatively addressed.

In a first exemplary embodiment of the disclosure, an analog field device can be connected to an analog input interface having a plurality of channels. Then, the topological indicator 11 specifies that channel of the analog input interface to which the respective field device can be connected.

In an alternative exemplary embodiment of the disclosure, a digital field device can be connected to a field bus. Then, the topological indicator 11 specifies the physical address at which the respective field device can be reached via the field bus.

The status symbol 12 can be an exchangeable graphical representation of the present availability state of the field device within the automation installation. In an exemplary embodiment of the disclosure, a status symbol “online” can be displayed once a device communication between the device management software and the field device has been brought about, while otherwise a status symbol “offline” can be displayed.

In another configuration of the disclosure, provision can be made for the status symbol 12 to be designed as an indicator according to NAMUR Recommendation NE 107. For example, this can include symbols for signalling error states, maintenance requirements, functional checks of the field device or for indicating that the field device can be operated outside of its specification.

In another configuration of the disclosure, provision can be made for the screen element 1 to have a color marking 15 which can be illustrated using hatching in FIG. 1. In an exemplary embodiment, the color markings 15 correspond in color to the indicators according to NAMUR Recommendation NE 107.

The identifier 13 can be an unambiguous identification item of the field device within the automation installation. The identifier, a so-called “TAG name”, can be an alphanumeric description of a physical entity within an identification scheme of the respective automation installation.

The operating element 14 can be a sensitive region of the screen element 1 for calling expanded displays and/or functions of the field device. When the operating element 14 can be actuated, the screen element 1 can be expanded in terms of area. The additional display area can be suitable for displaying further device information.

The screen element 1 illustrated in FIG. 1 shows, for example, a field device with the identifier “34-LRS-PIX-007S”, the status symbol “online” and the topological indicator “Ch.2”, which indicates that the field device can be connected to channel 2 of an analog interface.

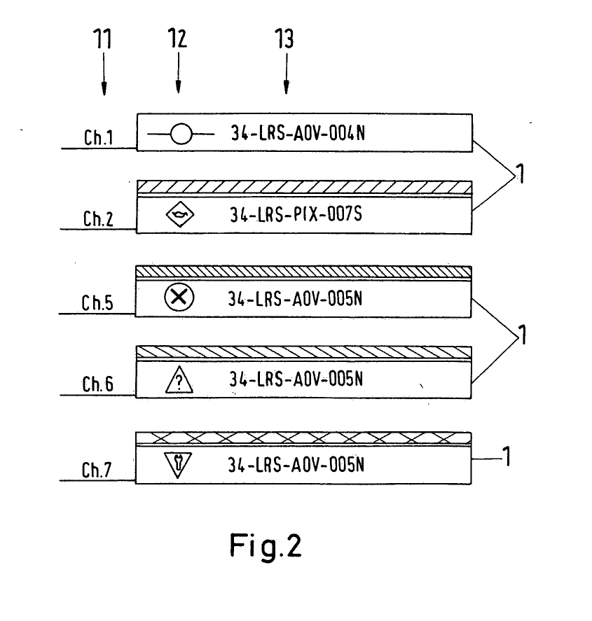

FIG. 2 is an exemplary illustration of a device list with a plurality of screen elements 1 which each represent a field device in the automation installation in the configuration tool. Each screen element 1 designates a different topological indicator 11, “Ch.1” to “Ch.7”, for the respective field device which in each case bears an unambiguous identifier 13. Furthermore, the status symbols 12 of the field devices with the topological indicators “Ch.2” to Ch.7” indicate the indicators according to NAMUR Recommendation NE 107.

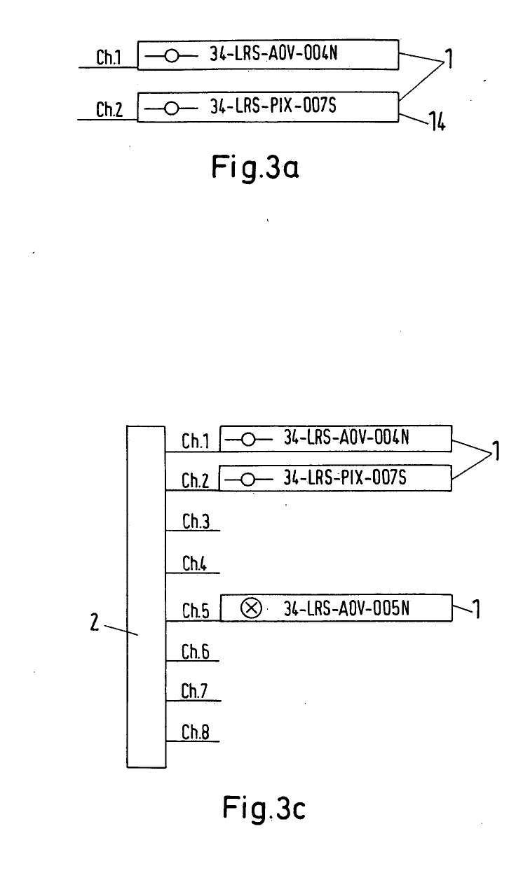

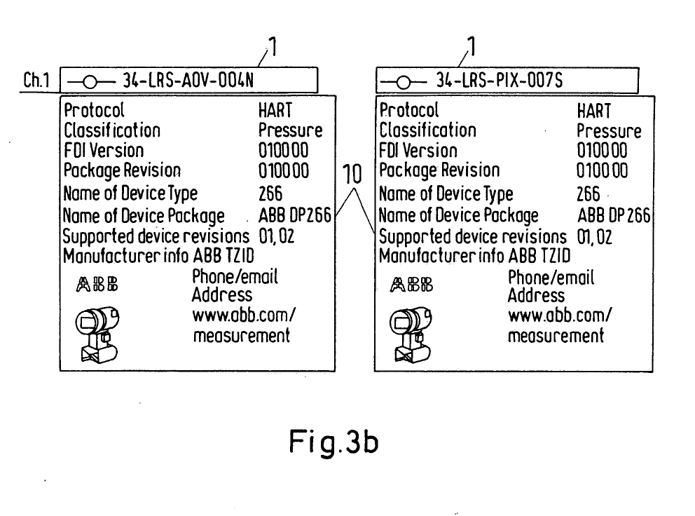

FIGS. 3a-3c show an exemplary illustration of the mode of operation of the expanded display of a screen element in the configuration tool.

Proceeding from the list representation of the screen elements 1 according to FIG. 3a, the respective screen element 1 can be expanded in area around a detail region 10 by actuation of an operating element 14. The expanded display according to FIG. 3b can be suitable for providing the user with additional information relating to the respective field device, which additional information can be indicated in the detail region 10. This may include protocol information, revision data, manufacturer information and a pictorial representation of the field device. Another actuation of the operating element 14 of the respective screen element 1 minimizes the display of the respective screen element 1 in the output state.

In accordance with an exemplary embodiment, a provision can be made for the minimized display of the screen element 1 according to FIG. 3c to be displayed as a connection list, in the case of which the screen elements 1 are displayed at least in part in the topological structure thereof, wherein the free channels of a superordinate distributor 2 can be designated in the form of topological indicators 11. In this case, the distributor 2 can be an analog interface device or a digital field bus.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 screen element
10 detail region
11 topological indicator
12 status symbol
13 identifier
14 operating element
15 color marking
2 distributor

What is claimed is:

1. A device for managing and configuring field devices in an automation installation, the device comprising:
a configuration tool which is configured to physically detect a field device in the automation installation, to logically incorporate the field device into the automation installation, and to configure the field device in the automation installation, the configuration tool including a predefined first field-device-specific information packet which at least partially describes functions and data of the field device; and
wherein the configuration tool is configured to represent all field devices in each case by identical screen elements, and wherein each of the identical screen elements has a same construction and a same function independently of a location of a device selection.

2. The device as claimed in claim 1, wherein each of the identical screen elements comprises:
at least one identifier and an operating element.

3. The device as claimed in claim 2, wherein each of the identical screen elements comprises:
a topological indicator.

4. The device as claimed in claim 2, wherein each screen of the identical elements comprises:
a status symbol.

5. The device as claimed in claim 3, wherein each of the identical screen elements comprises:
a status symbol.

6. The device as claimed in claim 4, wherein each of the identical screen elements comprises:
a color marking which corresponds to the status symbol.

7. The device as claimed in claim 2, wherein each of the identical screen elements is associated in a callable manner with a detail region which is activatable by actuation of the operating element.

8. The device as claimed in claim 2, wherein an entire area of the identical screen element is designed as a sensitive area of the operating element.

9. The device as claimed in claim 1, comprising:
a superordinate distributor configured to display each of the identical screen elements at least in part in a topological structure having topological indicators.

10. The device as claimed in claim 9, wherein the distributor is an analog interface device or a digital field bus.

11. A method for managing and configuring field devices in an automation installation, the method comprising:
configuring a configuration tool to physically detect a field device in the automation installation, to logically incorporate the field device into the automation installation and to configure the field device in the automation installation, the configuration tool including a predefined first field-device-specific information packet which at least partially describes functions and data of the field device; and
representing all field devices in each case by identical screen elements in the configuration tool, wherein each of the identical screen elements has a same construction and a same function independently of a location of a device selection.

12. The method as claimed in claim 11, wherein each of the identical screen elements comprises:
at least one identifier and an operating element.

13. The method as claimed in claim 12, wherein each of the identical screen elements comprises:
a topological indicator.

14. The method as claimed in claim 12, wherein each screen of the identical elements comprises:
a status symbol.

15. The method as claimed in claim 13, wherein each of the identical screen elements comprises:
a status symbol.

16. The method as claimed in claim 14, wherein each of the identical screen elements comprises:
a color marking which corresponds to the status symbol.

17. The method as claimed in claim 12, comprising:
associating each of the identical screen elements in a callable manner with a detail region which is activatable by actuation of the operating element.

18. The method as claimed in claim 12, comprising:
designing an entire area of the identical screen element as a sensitive area of the operating element.

19. The method as claimed in claim 11, comprising:
a superordinate distributor configured to display each of the identical screen elements at least in part in a topological structure having topological indicators.

20. The method as claimed in claim 19, wherein the distributor is an analog interface device or a digital field bus.
